(19) United States
(12) Patent Application Publication
(10) Pub. No.: US 2012/0017377 A1
(43) Pub. Date: Jan. 26, 2012

(54) Combination Measuring and Pipe Cutting Device

(76) Inventor: Andrew Hayden, St. Albans, VT (US)

(21) Appl. No.: 13/179,588

(22) Filed: Jul. 11, 2011

Related U.S. Application Data
(60) Provisional application No. 61/366,702, filed on Jul. 22, 2010.

(51) Int. Cl. B25F 1/00; B23D 21/08

(52) U.S. Cl. 7/157

(57) ABSTRACT

The present invention provides a measuring tool and cutting device for use with metal pipes and tubes. The device provides accurate measurement of a length of pipe and a tool to cut sections thereof. The device comprises a crescent shaped pipe cutter with a measuring portion affixed to its distal end. The measuring portion is a retractable tape measuring device that allows the user to place the cutting tool at a specific distance from an end of the pipe. Once positioned at the desired location, the device grips and secures to the pipe using a scoring blade and two rollers. The measuring tape is then retracted and the user rotates the cutting device around the pipe to score and cut the pipe at that location. The device is small and compact, and may be used in a plurality of situations and locations involving pipes and pipe fitting. It is designed for quick access to a measuring means and for rapidly measuring and scoring sections of pipe.

### CROSS REFERENCE TO RELATED APPLICATION

This application claims the benefit of U.S. Provisional Application No. 61/366,702 filed on Jul. 22, 2010, entitled “Donkey Tape Cutter.”

### BACKGROUND OF THE INVENTION

1. Field of the Invention

The present invention relates generally to devices for measuring and cutting lengths of elongated objects, and more specifically a novel device that both measures and cuts metal piping.

Plumbers and consumers involved in various home construction projects may frequently be required to measure and cut sections of pipe. To complete this process, users must first measure the pipe and then cut it to the appropriate length, requiring the use of tape measurers, marking tools and pipe cutters. Going through each step individually may be time-consuming and frustrating, particularly if many consecutive sections of pipe are being measured and cut during a project. A single user may also find it awkward to cut longer lengths of pipe without help from others or without spending ample time to ensure an accurate measurement for each section. Further, if one tool in this process is misplaced, workers will not be able to complete the measuring and cutting operation with any accuracy. Instead, extra time will be expended searching for the tool or recutting sections of pipe that do not fit, resulting in a delay of the overall completion of the project that can be costly both in time and money.

Thin-walled piping formed of copper, steel, plastic, or other material is used extensively in plumbing, heating and ventilating, electrical installations, and in other construction applications. Although occasionally flexible, most cylindrical piping is typically rigid and must be cut to a specific size to conform to the geometry of the building structure or of the installed apparatus with which it is to be connected. Although fine tolerances are usually not required, pipe cuts must be made with some accuracy to be sure of acceptable joints and performance without creating wasted sections of pipe that are too short or are otherwise nonconforming.

When a plumber or pipe fitter undertakes a task requiring a number of pipes of varying lengths, he normally measures the lengths of each pipes by means of a measuring tape, marking each length along the pipe and the associated cut locations. This method of measuring pipe is not only tedious, but it is also time consuming. Additionally, unless two individuals participate in such an operation, there is an improved likelihood of error with regards to the many measurements that take place. The loss of time and money resulting from erroneous measurements is readily apparent and a clear drawback to the present methods involved in measuring sections of pipe.

Pipe cutters that use rigid measuring fixtures or ruling bars to measure are generally known. However, these devices are large, cumbersome, and not suited for portable use. What is needed is a device which is both portable and may be conveniently utilized by a tradesman to both measure a length of pipe and cut it at a specific location to produce a desired length without secondary tools.

The present invention addresses the need for a simple use, combination device for the measuring and cutting a section of pipe.

2. Description of the Prior Art

Several patents have issued related to processes and devices required for measuring and cutting pipes. However, none of these patents completely fulfills the needs in the art addressed by the present invention.

Clor U.S. Pat. No. 2,780,870 is directed to an improved pipe measuring apparatus and one that may be employed on a pipe cutting machine. The Clor invention discloses a device that only addresses measuring a length of pipe. The present invention addresses both the measurement and cutting of the pipe, without employing a larger structure or tool.

Swatek U.S. Pat. No. 5,301,427 is directed to a rigid housing having an axially extending opening which receives a length of pipe or tubing therethrough. A measuring assembly is mounted to the housing and has a circular friction wheel that is rotatable about an axis perpendicular to the axis of the tubing. A cutting assembly is mounted to a housing and has a cutting blade that is rotatable about an axis substantially perpendicular to the friction wheel axis. The cutting assembly is vertically adjustable to be clear of the pipe as it is advanced through the housing, and to be brought into cutting contact when the desired length of tubing is shown on the display. Spring-loaded wedges are adjustable to securely position tubing of different diameters.

The Swatek invention describes an electronic device capable of measuring pipe lengths and aligning the pipes appropriately for cutting. While somewhat automatic, the Swatek device sacrifices several of the advantages of manual cutters. Specifically the Swatek device is bulky, and would be difficult to use in situations where a pipe is already installed. Frequently, users of measuring devices and pipe cutters must remove known lengths of installed pipe. Such pipes may be difficult to reach or in extremely confined locations. The size and nature of the Swatek device would not be conducive to such use. The present invention is designed to be a useful pipe measuring and cutting tool in all situations.

Davison U.S. Pat. No. 6,546,630 is directed to a hand-held measuring and cutting device for pliable tubing, manmade or natural cordage, roping, etc. The device comprises a plurality of diametrically opposing rigid substrates that provide surfaces for insertion therein and a conventional type linear measuring counter for measuring pliable material prior to cutting. Additionally, a blade and blade plunger, handle, compressor member, and feed hole, attached or inserted therein or thereto, provide for single-hand operation of the measuring and cutting device. The device so incorporating a conventional counter and being so designed for single-handed operation provides a single, easy to use, time saving tool for use in the current process of measuring and cutting bulk supplied pliable materials. The Davison device is useful for measuring and cutting bulk, pliable materials, but does not address the cutting of rigid materials such as metal pipe. The present invention particularly addresses the issue of rigid pipe cutting such as copper or other non-pliable pipe.

While there are several related inventions in the art, none of these fully addresses the issue of providing a simple to use combination measuring and cutting tool for sections of pipe, and one that does not require a secondary tool or larger apparatus to operate. Prior inventions either do not both measure and cut, fail to be useful in many common pipe cutting situations and locations, or are directed to pliable materials. The present invention fills a current need in the art by providing an easily deployed pipe measuring and cutting device that is usable in any situation or location. Its structure and intent substantially diverges in design elements from the prior art and consequently it is clear that there is a need for an improvement to existing pipe cutting and measuring tools now present in the art. In this regard the instant invention substantially fulfills these needs.

### SUMMARY OF THE INVENTION

In view of the foregoing disadvantages inherent in the known types of pipe measuring or cutting devices now present in the prior art, the present invention provides a new device capable of both measuring and cutting sections of pipe wherein the same can be utilized for providing convenience for the user when installing, removing, fitting or otherwise attaching rigid piping that requires specific lengths.

The present invention is a device used to measure and cut copper or other metal pipes. The invention allows consumers to accomplish both of these tasks simultaneously with a single device, thus reducing time and effort required to complete a project. The device combines a tape measure component with a pipe cutter component to create a novel, convenient tool that is easy to use by a single practitioner with limited learning or deviation from conventional methods. The device can cut lengths of pipe commonly found in water heaters, heating coils, bypass loops, and other similar items, as well as larger pipes commonly used for routing plumbing throughout buildings and other structures. The device is compact in nature, allowing use in a plurality of situations and locations in which metal pipes may be installed, removed or replaced.

It is therefore an object of the present invention to a novel and improved pipe measuring and cutting device. Further, such a device should be compact in design and be deployable by a single user for rapidly measuring and cutting sections of pipe as required without a marking tool or secondary measuring, clamping or cutting means.

Another object of the present invention is to provide a pipe measuring and cutting device that provides the user with a tool to accurately perform a pipe measuring and cutting operation in a minimum amount of time by a single practitioner.

Yet another object of the present invention is to provide a robust pipe measuring and cutting device that is of simple design and of rugged construction to afford a long and useful service life.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention, including the measuring means, cutting means a handle portion.

FIG. 2 shows a perspective view of the present invention in use, including a view of the measuring means in operation and the scoring means in a working position.

FIG. 3 shows a side view of the present invention.

### DETAILED DESCRIPTION OF THE INVENTION

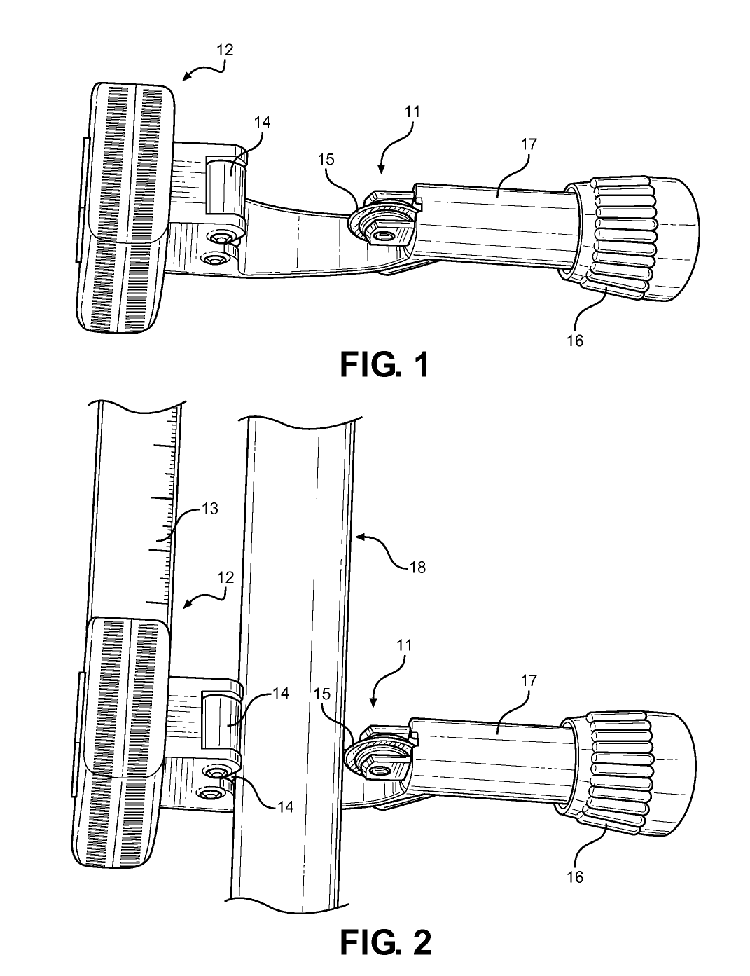

Referring now to FIG. 1, there is shown a perspective view of the present invention. The device comprises a measuring means in the form of a measuring tape spool 12 affixed to the distal end of a crescent shaped pipe scoring and cutting means 11. The cutting means 11 comprises a crescent-shaped, pipe cutting body with a pair of support rollers 14 for accepting a rounded cross section of pipe within the cutting means, along with a scoring roller mounted opposite the rollers 14. A handle 17 is provided below the scoring roller 15 for the user to grip the tool prior to a cutting operation and for rotation of the tool around a pipe after securement thereto. A tightening knob 16 is provided at the base of the handle to adjust the scoring roller 15 location with regard to the pipe rollers 14, and therefore the distance therebetween. As the tightening knob 16 is rotated, the scoring roller 15 is advanced, forcing a pipe work piece against the opposing rollers 14. Once the pipe work piece is secured and the scoring roller 15 is sufficiently tightened against the outer surface of the pipe, the user rotates the device around the pipe to score and eventually cut the pipe. The tightening knob 16 is further advanced as needed to secure and score deeper into the pipe cross section.

Prior to clamping and securing the cutting means 11 to the section of pipe, the measuring means 12 is utilized to measure the distance from the scoring roller 15 to a desired location, typically the end of a length of pipe. In this manner, the exact length of pipe is measured and known as the cutting means 11 is applied. This reduces measuring and cutting operation, as the scoring roller 15 can be quickly aligned and secured without first marking the pipe, yielding a single operation that provides an accurate length of pipe in minimal time and operation steps.

Varying diameters of pipe may be accommodated for by advancing or retracting the scoring roller 15 within the cutting body, thereby closing or opening a gap between the scoring roller 11 and the opposing pipe rollers 14. The crescent shape of the tool provides clearance for the largest allowable gap between to the rollers 14 and scoring rollers 15 within the cutting means 11, eliminating any chance of interference with larger piping diameters. Further, the pipe rollers act as roller bearing to allow the scoring roller 15 to easily rotate around the outer surface of the pipe without undue friction or loss of securement thereto.

Referring now to FIG. 2, there is shown a perspective view of the present invention in use with the measuring means 12 in a working position, and a section of pipe being placed within the pipe cutting means 11. The pipe is secured in the crescent shaped pipe cutting means 11 between the scoring roller 15 and the pipe support rollers 14. The measuring means comprises a spool of wound measuring tape 13, which allows extension of measuring tape 13 stored therein and compact storage thereof. The measuring tape 13 can be extended as with a traditional measuring tape, secured to a static position and automatically retracted using a retraction means, including a rotational spring or similar device. The retractable measuring tape 13 is extended from the measuring spool to determine the proper length of pipe to be scored and cut. The measuring tape 13 can be extended and secured in a static position prior to attaching the scoring means to a pipe, or likewise the user can extend the tape 13 and secure the cutting means 11 simultaneously, depending on user skill, experience or degree of accuracy required. To cut the pipe, the practitioner grips the handle 17 and rotates the device around the pipe to allow the scoring roller 15 to remove material from the pipe cross section at the cutting location. The user turns the tightening knob 16 to gradually increase the scoring pressure and finally cut the pipe when no more material is present in the cross section being scored.

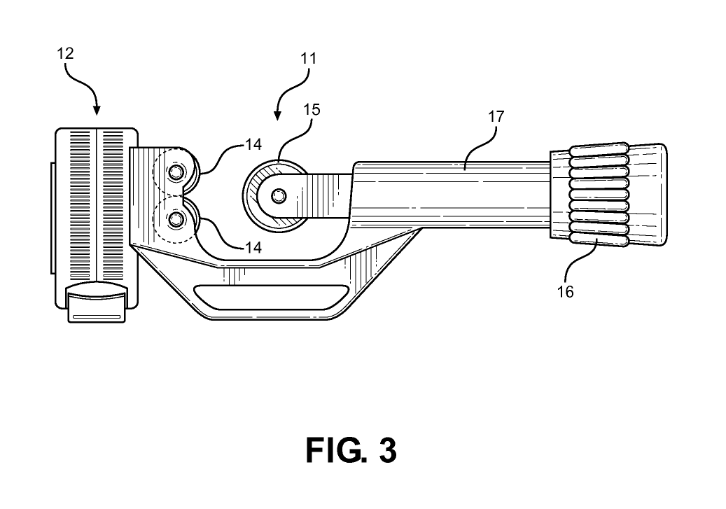

Referring now to FIG. 3, there is shown a side view of the present invention. Located at the distal end of the crescent-shaped, pipe cutting means 11 is the measuring means 12. A handle 17 is provided along the pipe cutting means 11 for transport and utilization thereof. A tightening knob 16 at the base of the handle allows the user to advance or retract the scoring roller 15, applying clamping pressure a pipe secured between the roller 15 and the support rollers 14. The user grips the handle 17 with a first hand and rotates the knob 16 with a second hand. The handle 17 is also provided for leverage while scoring and turning the tool about the pipe work piece.

The present invention increases the speed and efficiency with which users may measure and cut piping and tubing. The device may comprise a tool in which the top portion resembles a tape measure spool with retractable measuring tape 13, or likewise resemble any retractable measuring means that accomplishes the same task. Attached to this component is the distal end of a crescent shaped pipe cutting means 11 with a handle 17 and scoring roller 15. It is not desired to limit the present invention to a particular measuring tape design or pipe scoring tool, but to disclose a combination thereof that provides a measuring means and pipe cutting means that reduces effort on the user and reduces time required to measure sections of pipe. The associated figures are desired to be illustrative of an exemplary embodiment of the present invention that is known to be particularly suited for the given task. Protection for alternate measuring means and pipe scoring or cutting means is desired, falling within the scope and spirit of the present disclosure.

In use, the retractable tape 13 is extended outward from a spool stored within the tape measuring means 12 to measure the desired length of pipe. Once the appropriate measurement has been determined, the user aligns the pipe at the desired length within the pipe cutting means 11. The user then turns the tightening knob 16 at the base of the handle to advance the scoring roller 15, securing the pipe in within the body of the cutting means 11 between the scoring roller 15 and the supporting rollers 14. The practitioner then proceeds to retract the retractable tape 13 and rotates the device around the pipe after sufficient pressure has been applied by the scoring roller 15 against the outer surface of the pipe work piece. The rollers 14 assist in rotating the device around the pipe, while securely holding the pipe within the body of the cutting means 11. As the device is rotated, the tightening knob 16 is further tightened to cause the blade 15 to score deeper into the pipe cross section and eventually cut the pipe. For added convenience, the device may be operated using only a single hand.

The measuring means 12 origin must align with the location of the scoring roller 15, or the end of the measuring tape 13 must account for the distance from the scoring roller 15 to the outlet of the measuring tape 13 to ensure the measurement taken from the elongated length of measuring tape 13 is the distance from the end of the tape to the cutting location. Without this alignment, the scoring roller 15 may cut a pipe work piece at an undesired length, resulting in wasted time and material.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A combined pipe measuring and cutting device, comprising:
a tape measuring means comprising a spool of wound measuring tape, said spool being spring loaded and affixable to allow automatic retraction and static extension of said tape;
a pipe cutting means, comprising a crescent-shaped body, a distal end and handle end;
pipe support rollers and an opposing pipe scoring roller positioned within said body, said rollers providing a gap to place a pipe work piece,
a tightening knob attached to said handle for adjusting said pipe scoring roller position and changing said gap between rollers,
said tape measuring means being attached to said pipe cutting means distal end.

2. A device as in claim 1, wherein said measure tape comprises an offset distance to accommodate a distance from said tape measuring means origin and said pipe scoring roller location along said pipe work piece to ensure proper measurement of said pipe work piece.

3. A device as in claim 1, wherein said measure tape originates at said pipe scoring roller to ensure proper measurement of said pipe work piece.
